(19) United States
(12) Patent Application Publication
(10) Pub. No.: US 2026/0023475 A1
(43) Pub. Date: Jan. 22, 2026

(54) APPLICATION CREATION

(71) Applicant: Beijing Zitiao Network Technology Co., Ltd., Beijing (CN)

(72) Inventors: Yibo LI, Beijing (CN); Hanlin HE, Beijing (CN); Yuyang PAN, Beijing (CN)

(21) Appl. No.: 18/974,244

(22) Filed: Dec. 9, 2024

(30) Foreign Application Priority Data
Jul. 16, 2024 (CN) 202410955229.4

(51) Int. Cl. G06F 3/04847; G06F 8/34

(52) U.S. Cl. CPC G06F 3/04847; G06F 8/34

(57) ABSTRACT

Embodiments of the disclosure relate to a method a device, and a storage medium and an apparatus for creating an application. The method includes: obtaining configuration information, the configuration information includes interactive control information about a target interactive scene, where the interactive control information is configured to construct a first processing entity corresponding to the target interactive scene, such that the first processing entity manages, based on the interactive control information, an interaction process for a set of interactive objects participating in the target interactive scene. The configuration information further indicates a set of scene variables associated with the target interactive scene, each scene variable of the set of scene variables being configured to provide a corresponding value to one or more corresponding interactive objects during the interaction process; and creating a target application based on the configuration information.

### CROSS REFERENCE

The present application claims priority to Chinese Patent Application 202410955229.4, filed on Jul. 16, 2024, and entitled “METHOD AND APPARATUS FOR CREATING APPLICATION, DEVICE AND STORAGE MEDIUM”, the entirety of which is incorporated herein by reference.

### TECHNICAL FIELD

Example embodiments of the present disclosure generally relate to the field of computers, and more particularly, to creating an application.

### BACKGROUND

With the development of computer technology, people may create and publish various types of applications through different platforms. For example, with the development of machine learning technologies, people can quickly create an application by configuring parameters of the application, such as models used by the application, available plug-ins, and so on.

### SUMMARY

In a first aspect of the present disclosure, a method for creating an application is provided. The method includes: obtaining configuration information, the configuration information including interactive control information about a target interactive scene, where the interactive control information is configured to construct a first processing entity corresponding to the target interactive scene, such that the first processing entity manages, based on the interactive control information, an interaction process for a set of interactive objects participating in the target interactive scene, the configuration information further indicating a set of scene variables associated with the target interactive scene, each scene variable of the set of scene variables being configured to provide a corresponding value to one or more interactive objects during the interaction process; and creating a target application based on the configuration information.

In a second aspect of the present disclosure, an apparatus for creating an application is provided. The apparatus includes: an obtaining module configured to obtain configuration information, the configuration information comprising interactive control information about a target interactive scene, where the interactive control information is configured to construct a first processing entity corresponding to the target interactive scene, such that the first processing entity manages, based on the interactive control information, an interaction process for a set of interactive objects participating in the target interactive scene, and the configuration information further indicates a set of scene variables associated with the target interactive scene, each scene variable of the set of scene variables being configured to provide a corresponding value to one or more interactive objects during the interaction process; and a creating module configured to create a target application based on the configuration information.

In a third aspect of the present disclosure, an electronic device is provided, the device including at least one processing unit; and at least one memory, the at least one memory being coupled to the at least one processing unit and storing instructions for execution by the at least one processing unit, the instructions, when executed by the at least one processing unit, cause the electronic device to perform operations that implement the method of the first aspect.

In a fourth aspect of the present disclosure, a computer readable storage medium is provided, where the computer readable storage medium stores a computer program thereon, and the computer program is executable by a processor to perform operations that implement the method in the first aspect.

It should be appreciated that what is described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, where:

FIG. 1 illustrates a schematic diagram of an example environment.

FIG. 2 illustrates a flowchart of an example process for creating an application.

FIGS. 3A-3C illustrate example interfaces.

FIG. 4 illustrates a schematic structural block diagram of an example apparatus for creating an application.

FIG. 5 illustrates a block diagram of an example electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

It should be noted that the headings of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

In the description of the embodiments of the present disclosure, the term “including”, and the like should be understood as open-ended including, that is, “including but not limited to”. The term “based on” should be read as “based at least in part on.” The term “one embodiment” or “the embodiment” should be read as “at least one embodiment”. The term “some embodiments” should be understood as “at least some embodiments”. Other explicit and implicit definitions may also be included below. The terms “first”, “second”, etc. may refer to different or identical objects. Other explicit and implicit definitions may also be included below.

Embodiments of the present disclosure may relate to data, acquisition and/or use of data, etc. by a user, all following respective legal regulations and related regulations. In embodiments of the present disclosure, all data collection, acquisition, processing, processing, forwarding, use, and the like, are made with user knowledge and confirmation. Accordingly, when implementing the embodiments of the present disclosure, the user should be informed of the types of data or information that may be involved, a usage range, a usage scene, and the like in an appropriate manner according to relevant legal regulations, and the authorization of the user is obtained. The specific informing and/or authorization manner may vary according to actual situations and application scenes, and the scope of the present disclosure is not limited in this aspect.

In the present description and the embodiments, solutions, if personal information processing is involved, are performed on the basis of legitimacy (for example, the consent of the personal information body is obtained, or necessary for fulfillment of a contract, etc.), and is performed only within a specified range or an agreed range. The user rejects personal information other than the necessary information required for processing the basic function, and the use of the basic function by the user is not affected.

Conventionally, a user configures a model, a plug-in, and the like used by an application to quickly create an application, for example, a robot program (bot). However, the application created by the user typically only supports the user's interaction with a single intelligent volume or bot. This makes the interactive scenes that can be provided by user-created applications very limited.

Embodiments of the present disclosure propose a solution for creating an application. According to the solution, configuration information may be obtained, the configuration information including interactive control information about a target interactive scene, where the interactive control information is configured to construct a first processing entity corresponding to the target interactive scene, such that the first processing entity manages, based on the interactive control information, an interaction process of a set of interactive objects participating in the target interactive scene, the configuration information further indicates a set of scene variables associated with the target interactive scene, and the set of scene variables are configured to be provided to corresponding interactive objects during the interaction process. Further, the target application may be created based on the configuration information.

In this manner, the embodiments of the present disclosure can allow for the configuration of one or more scene variables in an interactive scene to provide corresponding interactive objects participating in the interactive scene. This enables an interactive object to further participate in the interaction process according to the scene variables, thereby improving the controllability of the interaction process.

Various example implementations of the solution are described in further detail below with reference to the accompanying drawings.

### Example Environment

FIG. 1 shows a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. The application 120 can be any suitable type of application for interface interaction, examples of which may include, but are not limited to, a development application or other suitable application that supports workflow creation. A user 140 may interact with application 120 via electronic device 110 and/or an attached device thereof.

In the environment 100 of FIG. 1, if the application 120 is active, the electronic device 110 may present an interface 150 through the application 120 to support creation of the application.

In some embodiments, the electronic device 110 communicates with server 130 to enable the provision of services to application 120. The electronic device 110 may be any suitable type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, and a Personal Communication System, a PCS) device, personal navigation device, personal digital assistant (PDA), audio/video player, digital camera/camcorder, positioning device, television receiver, radio broadcast receiver, electronic book device, game device, or any combination of the foregoing, including accessories and peripherals for these devices, or any combination thereof. In some embodiments, electronic device 110 can also support any type of interface to a user (such as a “wearable” circuit or the like).

The server 130 may be an independent physical server, may also be a server cluster or a distributed system formed by a plurality of physical servers, and may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, etc. The server 130 may provide background services for the virtual scene-enabled application 120 in the electronic device 110.

A communication connection may be established between the server 130 and the electronic device 110. The communication connection may be established in a wired manner or a wireless manner. Communication connections may include, but are not limited to, Bluetooth connections, mobile network connections, Universal Serial Bus (USB) connections, Wireless Fidelity (Wi-Fi) connections, and the like, to which embodiments of the present disclosure are not limited. In embodiments of the present disclosure, the server 130 and the electronic device 110 may enable signaling interaction through a communication connection therebetween.

It should be understood that the structure and function of the various elements in environment 100 are described for exemplary purposes only and are not intended to imply any limitation on the scope of the disclosure.

Some example embodiments of the present disclosure will be described below with continued reference to the accompanying drawings.

### Example Process For Application Creation

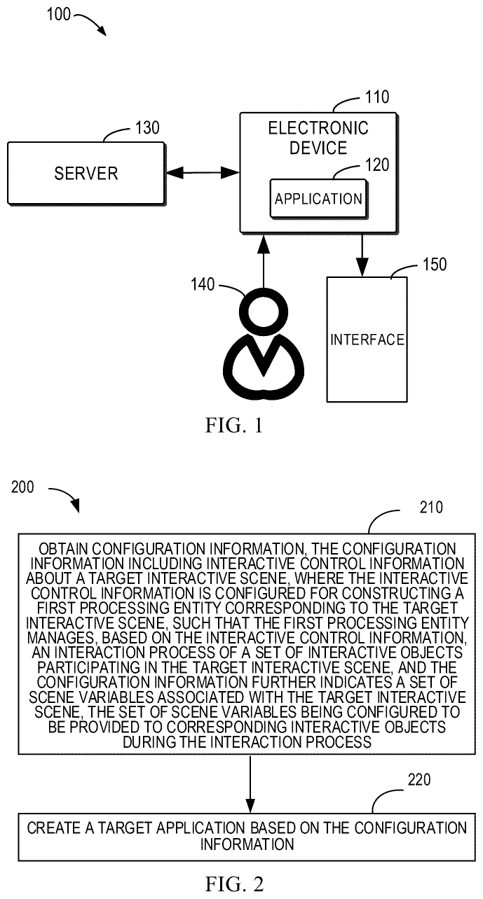

FIG. 2 illustrates a flowchart of a process 200 for creating an application according to some embodiments of the disclosure. The process 200 may be implemented at the electronic device 110. The process 200 is described below with reference to FIG. 1.

At block 210, the electronic device 110 obtains configuration information. The configuration information includes interactive control information about a target interactive scene. The interactive control information is configured to construct a target processing entity corresponding to the target interactive scene such that the target processing entity manages, based on the interactive control information, an interaction process of a set of interactive objects participating in the target interactive scene. The configuration information further indicates a set of scene variables associated with the target interactive scene, and the set of scene variables are configured to be provided to corresponding interactive objects during the interaction process.

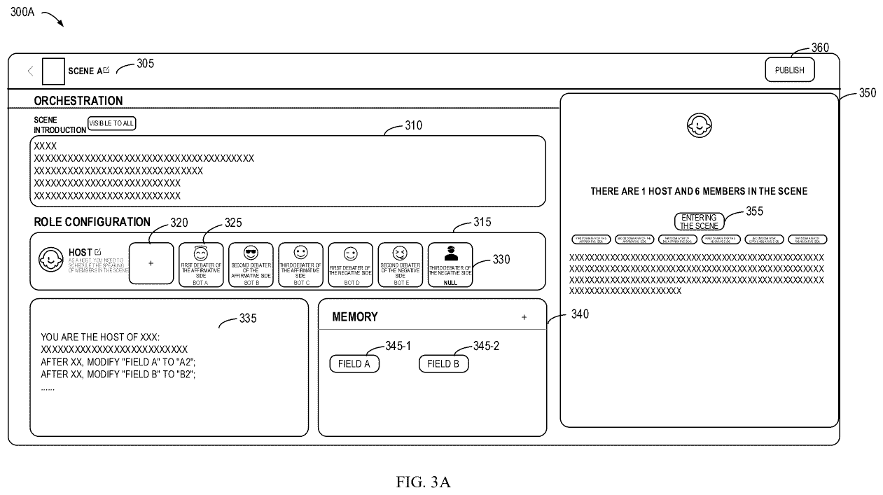

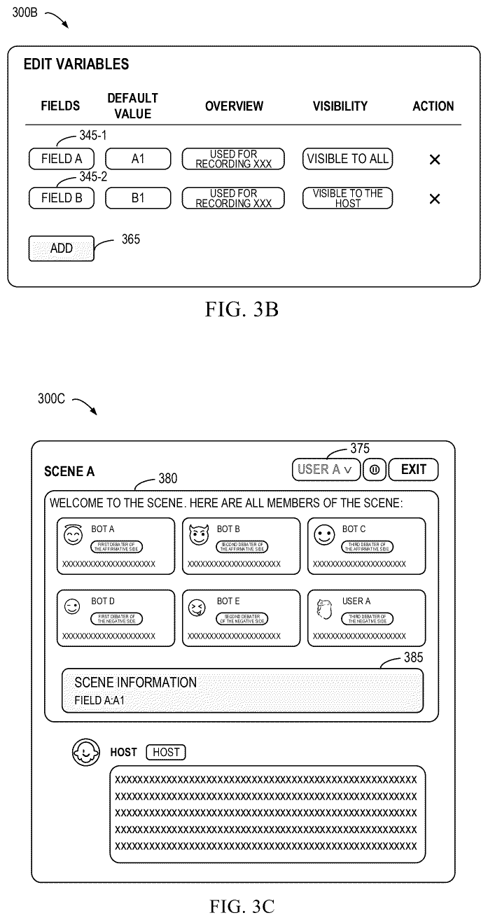

The specific process of obtaining the configuration information will be described further below in conjunction with FIGS. 3A-3C. FIGS. 3A-3C illustrate example interfaces according to some embodiments of the disclosure.

As shown in FIG. 3A, the electronic device 110 may present a configuration interface 300A as shown in FIG. 3A, based on a user's request for creation of an application. The configuration interface 300A may be used to receive configuration information to create an application associated with a target interactive scene.

By way of example, the electronic device 110 may present the configuration interface 300A based on an application identifier or a scene identifier (e.g., Scene A) 305 input by the user. As shown in FIG. 3A, the configuration interface 300A may include an input control 310 for obtaining scene description information about a target interactive scene.

As an example, such scene description information may include a piece of description text for describing an interactive scene to be created. Such scene description information may be public information visible to an interactive object participating in the interactive scene. In a case where the interactive object includes a predetermined processing entity (e.g., an intelligent agent, or other application such as a bot), such scene description information may be provided to a corresponding predetermined processing entity for controlling interaction of the predetermined processing entity in the interactive scene.

Taking a debate scene shown in FIG. 3A as an example, such scene description information may include, for example, a topic of the debate, a point of view of an affirmative side, a point of view of a negative side, and the like.

In some embodiments, as shown in FIG. 3A, the configuration interface 300A may further include a role configuration control 315 for obtaining a set of predetermined roles associated with the target interactive scene.

As shown in FIG. 3A, the electronic device 110 may allow the user to add multiple predetermined roles in an interactive scene. Taking a debate scene as an example, the user may add roles such as a first to a third debater of the affirmative side and a first to a third debater of the negative side.

In the interaction process, a set of interactive objects participating in the interactive scene are allocated to corresponding predetermined roles. As will be described below, such interactive objects may, for example, include user objects or may also include processing entities based on a configuration, such as an intelligent body or a bot, etc.

As shown in FIG. 3A, the electronic device 110 may provide an adding portal 320 for initiating a request for adding a role. After receiving a selection of the adding portal 320, the electronic device 110 may obtain role description information regarding the role to be added.

Additionally, the electronic device 110 may also determine visibility information for the role. The visibility information may be used to describe whether role information corresponding to the role is visible to other roles. Taking the debate scene as an example, role information of each interactive object is visible to other objects. Therefore, the user may, for example, set “First debater of the affirmative side” to be visible to all the roles.

As another example, in some interactive scenes, some interactive objects need to hide their role information at a particular stage. Accordingly, the user may set the visibility information of the role, for example, to be visible only to the host (as the processing entity for scheduling which will be described below).

Further, the electronic device 110 may also allow the user to associate the role with the predetermined processing entity or to associate the role with a null interactive object. The electronic device 110 may, for example, allow the user to select a predetermined processing entity (e.g., a BOT A) and associate the processing entity to the added role (e.g., the first debater of the affirmative side). As an example, the electronic device 110 may present a set of candidate processing entities that the user has permission to add (e.g., a set of Bots created by the user or to which the user has permission to access), and further may select a particular processing entity to associate to the role.

As an example, the electronic device 110 may also allow the replacing of an associated processing entity by the user. Further, the electronic device 110 may allow editing of an identifier (for example, a nickname) of the processing entity in the target interactive scene; and may edit a descriptive text regarding the processing entity.

In some embodiments, such identifier and descriptive text may be provided to other processing entities in the interactive scene. For example, the identifier and descriptive text may be provided to a processing entity associated with other roles, or a specific processing entity for scheduling, etc.

With continued reference to FIG. 3A, the electronic device 110 may display in the role configuration controls 315 the role indication elements corresponding to the added one or more predetermined roles, e.g., the role indication element 325 and the role indication element 330.

As shown in FIG. 3A, the role (e.g., the first debater of the affirmative side) corresponding to the role indication element 325 may be associated with a designated processing entity. Accordingly, the role indication element 325 may display an image identifier corresponding to the designated processing entity (e.g., an image identifier of a Bot), a name of the role and a nickname of the associated processing entity in the interactive scene, etc.

As another example, the role (e.g., the third debater of the negative side) corresponding to the role indication element 330 is associated with a null interactive object. In some scenes, the association with the null interactive object may indicate that the role is not provided with a corresponding predetermined processing entity. That is, other users may designate to participate as a user and associate with the role during an interaction with the target application, or other processing entities may be selected and associated with the role.

In particular, if a specific role is associated with a null interactive object, the electronic device 110 may further control the target application to provide an object configuration window for configuring the target interactive object corresponding to the role. For example, the electronic device 110 may set the user object as the target interactive object based on the user's configuration operation, or may also set a particular processing entity indicated by the user as the target interactive object.

For example, where the role of “the third debater of the negative side” is associated with a null interactive object, the user may start the application and select himself or a particular processing entity (e.g., bot) as the role of “the third debater of the negative side” to participate in the interactive scene.

Accordingly, as shown in FIG. 3A, the role indication element 330 may display corresponding object information (e.g., “null”) to indicate that it is associated with a null interactive object. In addition, the role indication element 330 may display a predetermined image content.

Further, as shown in FIG. 3A, the configuration interface 300A may further include an input control 335 for obtaining interactive control information. In some embodiments, the interactive control information may include a piece of text that describes an interaction rule and/or a control logic for the interactive scene.

In some embodiments, such interactive control information may be provided for creating the target processing entity (i.e., the host role mentioned above) in the interactive scene. In some embodiments, the target processing entity (also referred to as the first processing entity) may be configured to manage the interaction process of a plurality of interactive objects in the interactive scene.

Continuing to take the debate scene as an example, the interactive control information may describe, for example, a procedure of the whole debate process, a speaking order of each debater, content that needs to be output by the host role, and the like.

In some embodiments, such target processing entities may be implemented based on a machine learning model. For example, the electronic device 110 may provide the interactive control information obtained via the input control 335 to a target model to instruct the target model to manage the interaction process of the plurality of interactive objects in the interactive scene in accordance with content described by the interactive control information.

In some embodiments, as shown in FIG. 3A, the configuration interface 300A may further include a variable configuration control 340 for configuring one or more scene variables associated with the target interactive scene.

As shown in FIG. 3A, the target interactive scene may be associated with scene variables 345-1 and 345-2 (individually or collectively referred to as scene variables 345). In some embodiments, the electronic device 110 may receive a predetermined operation for the variable configuration control 340 and, in response, present a variable configuration interface 300B as shown in FIG. 3B.

As shown in FIG. 3B, the electronic device 110 may obtain the variable configuration information via the variable configuration interface 300B. Specifically, the variable configuration information may indicate, for example, an identifier of the scene variable 345 (e.g., also referred to as field name, variable name).

Alternatively, the variable configuration information may also indicate an initial value of the scene variables 345. As illustrated in FIG. 3B, the initial value of the scene variable 345-1 may be set to “A1”, and the initial value of the scene variable 345-2 may be set to “B1”.

Further, the variable configuration information may also indicate description information of the scene variables 345, such as, a description of the scene variables 345. Additionally, the variable configuration information may also indicate visible ranges for the scene variables 345. Specifically, a visible range may indicate that one or more specific interactive object may obtain the corresponding scene variable 345 during the interaction process.

For example, the visible range for the scene variable 345-1 may indicate that all the interactive objects may obtain the scene variable 345-1; or the visible range of the scene variable 345-2 may indicate that only a “host” (i.e., target processing entity) may obtain the scene variable 345-2.

In some embodiments, the electronic device 110 may also add more scene variables via an adding portal 365 provided by the variable configuration interface 300B. Alternatively, the electronic device 110 may also delete one or more existing scene variables.

In some embodiments, the electronic device 110 may also provide a debugging window 350 in the configuration interface 300A. As an example, the debugging window 350 may include, for example, a portal 355 for initiating debugging based on the current configuration information.

In some embodiments, the debugging window 350 may present a conversation interface engaged by the plurality of interactive objects (e.g., the configured processing entities and/or user objects) corresponding to the plurality of predetermined roles. The conversation interface may display interaction messages generated by the plurality of interactive objects in the interactive scene.

Continuing with the debate scene as an example, the host role may generate an opening message based on the scene description information and/or the interactive control information. Further, the predetermined processing entity corresponding to each debater role may generate a corresponding message, for example, according to the scene description information and the context information in a dialog. Accordingly, when a viewpoint needs to be expressed by a user object, the electronic device 110 may provide a corresponding message input control to enable the user to input a corresponding interaction message.

In block 220, electronic device 110 creates a target application based on the configuration information.

By way of example, the electronic device 110 may create a corresponding target application based on the configuration information. Further, the target application may be published or shared to other users, for example. As an example, the electronic device 110 may receive a user selection of a publish control 360 to accordingly create and publish the target application corresponding to the received configuration information.

In some embodiments, in a case that the target application configures the scene variables 345, the target application may provide the scene variables 345 to corresponding interactive objects at a runtime. Specifically, the scene variable 345-1 is taken as an example, and a visible range for the scene variable 345-1 includes all interactive objects.

Accordingly, during the runtime of the target application, the target application may provide the scene variables 345-1 to a processing entity (e.g., bot) and the user objects participating in the target interactive scene. For the processing entity (e.g., a BOT A), the target application may update prompt information (also referred to as a prompt item) corresponding to the processing entity using the scene variable 345-1. As an example, the target application may write the current value of scene variable 345-1 into the system prompt item of the BOT A.

In some embodiments, where the scene variable 345-1 is updated, the target application may further write the updated scene variable 345-1 to the system prompt item of the BOT A.

Accordingly, the system prompt item of the BOT A may concurrently include the current value of the scene variable 345-1 and one or more historic values.

In some embodiments, during the runtime of the target application, the target processing entity may update one or more scene variables 345 associated with the target interactive scene according to an interaction process.

In some embodiments, the target processing entity may update one or more scene variables in the set of scene variables 345 based on the interactive control information obtained via the input control 335. As shown in FIG. 3A, the interactive control information may include, for example, text content corresponding to an updating strategy for the scene variables 345 such that the target processing entity may update the scene variables 345 based on the text content.

In some embodiments, the target processing entity may also be associated with, for example, a workflow. Such workflow may include, for example, a variable updating node. The electronic device 110 may configure, via the variable updating node, an updating strategy associated with one or more scene variables in the set of scene variables 345, such that the target processing entity updates the corresponding scene variable based on the updating strategy.

In some embodiments, the workflow associated with the target processing entity may also support, for example, adding a variable reading node to read values of one or more scene variables associated with the target interactive scene. Such variable read node may further provide the read variable values to other nodes in the workflow.

In some embodiments, the set of scene variables 345 may be provided to the target processing entity during a runtime of the target application. For example, the target application may update prompt information corresponding to the target processing entity by using the set of scene variables 345.

For example, the target application may write the current values and historical values of all the scene variables 345 into a prompt item for the target processing entity to support the target processing entity in scheduling an interaction process of the target interactive scene based on the scene variables 345.

In some embodiments, the target application may also support viewing the values of the scene variables 345 during the interaction process. As shown in FIG. 3C, which shows a target window 300C of the target application. The target window 300C may be, for example, a debugging window or a running window of the target application.

As shown in FIG. 3C, the target application may display, in window 300C, description information 380 associated with the target interactive scene. For example, the description information 380 may display a plurality of interactive objects participating in the interactive scene. Additionally, the target application may also display variable information 385 to indicate a set of values, e.g., real-time values and/or historical values, of one or more scene variables (e.g., “Field A”) that the current interactive object (e.g., User A) corresponding to the target window is allowed to view.

In some embodiments, the electronic device 110 may receive a trigger operation from the user on a control 375 and switch the interactive objects corresponding to the target window. Accordingly, the electronic device 110 may update the variable information 385 accordingly, for example, to present current values and/or historical values of one or more scene variables provided to another interactive object.

Based on the processes described above, the embodiments of the present disclosure can enable configuration of one or more scene variables in an interactive scene, so as to provide the one or more scene variables to respective interactive objects participating in the interactive scene. This enables the interactive object to further participate in the interaction process according to the scene variables, thereby improving the controllability of the interaction process.

### Example Apparatus and Device

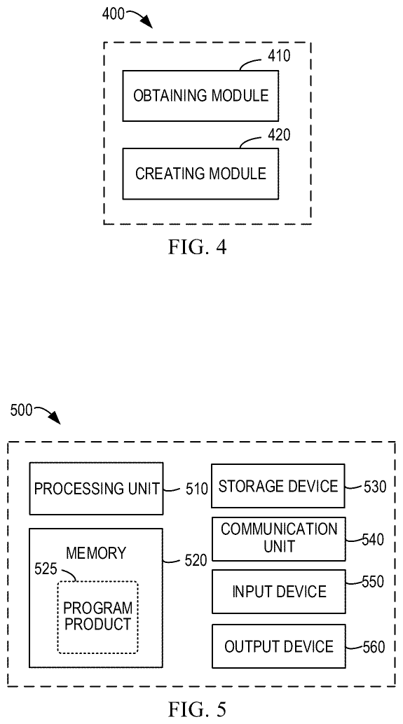

Embodiments of the present disclosure also provide corresponding apparatus for implementing methods or processes described above. FIG. 4 illustrates a schematic structural block diagram of an example apparatus 400 for creating an application in accordance with certain embodiments of the present disclosure. The apparatus 400 may be implemented as or included in the electronic device 110. The various modules/components in the apparatus 400 may be implemented by hardware, software, firmware, or any combination thereof.

As shown in FIG. 4, the apparatus 400 includes an obtaining module 410 configured to obtain configuration information, the configuration information including interactive control information about a target interactive scene, where the interactive control information is configured to construct a first processing entity corresponding to the target interactive scene, such that the first processing entity manages, based on the interactive control information, an interaction process for a set of interactive objects participating in the target interactive scene, and the configuration information further indicates a set of scene variables associated with the target interactive scene, each scene variable of the set of scene variables being configured to provide a corresponding value to one or more corresponding interactive objects during the interaction process; and a creating module 420 configured to create a target application based on the configuration information.

In some embodiments, the set of scene variables includes a target scene variable, and the target application is configured to: in response to the target scene variable being configured to be provided to a first interactive object corresponding to a second processing entity, update first prompt information corresponding to the second processing entity by using the target scene variable during a runtime of the target application.

In some embodiments, the first prompt information indicates a current value and at least one historical value of the target scene variable.

In some embodiments, the first processing entity is configured to update the set of scene variables during the interaction process.

In some embodiments, the first processing entity is configured to update a first scene variable in the set of scene variables based on the interactive control information.

In some embodiments, the first processing entity is associated with a workflow, the workflow includes a variable updating node, the variable updating node is configured to configure an updating strategy associated with a second scene variable in the set of scene variables, such that the first processing entity updates the second scene variable based on the updating strategy.

In some embodiments, the obtaining module 410 is further configured to present a variable editing interface and obtain variable configuration information via the variable editing interface, the variable configuration information indicating one or more attributes of the set of scene variables, the attributes being at least one of: identifiers of the scene variables; initial values of the scene variables; description information of the scene variables; or visible ranges for the scene variables.

In some embodiments, the target application is configured to update second prompt information corresponding to the first processing entity by using the set of scene variables during the runtime of the target application.

In some embodiments, the apparatus 400 further includes a trigger module configured to trigger a display of variable information in a target window of the target application, the target window corresponding to a second interactive object, and the variable information indicating a set of values of at least one scene variable provided to the second interactive object.

FIG. 5 illustrates a block diagram of an electronic device 500 in which one or more embodiments of the present disclosure may be implemented. It should be appreciated that the electronic device 500 shown in FIG. 5 is merely exemplary and should not constitute any limitation on the functionality and scope of the embodiments described herein. The electronic device 500 shown in FIG. 5 may be used to implement the electronic device 110 of FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communications units 540, one or more input devices 550, and one or more output devices 560. The processing unit 510 may be an actual or virtual processor and can perform various processes according to programs stored in the memory 520. In a multiprocessor system, a plurality of processing units executes computer executable instructions in parallel, so as to improve the parallel processing capability of the electronic device 500.

The electronic device 500 typically includes a number of computer storage media. Such media may be any available media that are accessible by electronic device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium such as a flash drive, a magnetic disk, or any other medium that can be used to store information and/or data and that can be accessed within the electronic device 500.

The electronic device 500 may further include additional removable/non-removable, volatile/nonvolatile storage media. Although not shown in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Thus, the electronic device 500 may operate in a networked environment using logical connections to one or more other servers, network personal computers (PCs), or another network node.

The input device 550 may be one or more input devices such as a mouse, keyboard, trackball, etc. The output device 560 may be one or more output devices such as a display, speaker, printer, etc. The electronic device 500 may also communicate with one or more external devices (not shown) such as a storage device, a display device, or the like through the communication unit 540 as required, and communicate with one or more devices that enable a user to interact with the electronic device 500, or communicate with any device (e.g., a network card, a modem, or the like) that enables the electronic device 500 to communicate with one or more other electronic devices. Such communication may be performed via an input/output (I/O) interface (not shown).

According to an exemplary implementation of the present disclosure, a computer readable storage medium is provided, on which a computer-executable instruction is stored, where the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for creating an application, comprising:
obtaining configuration information, the configuration information comprising interactive control information about a target interactive scene, wherein the interactive control information is configured to construct a first processing entity corresponding to the target interactive scene such that the first processing entity manages, based on the interactive control information, an interaction process for a set of interactive objects participating in the target interactive scene, and wherein the configuration information further indicates a set of scene variables associated with the target interactive scene, each scene variable of the set of scene variables being configured to provide a corresponding value to one or more interactive objects during the interaction process; and
creating a target application based on the configuration information.

2. The method of claim 1, wherein the set of scene variables comprises a target scene variable, and the target application is configured to:
in response to the target scene variable being configured to be provided to a first interactive object corresponding to a second processing entity, update first prompt information corresponding to the second processing entity by using the target scene variable during a runtime of the target application.

3. The method of claim 2, wherein the first prompt information indicates a current value and at least one historical value of the target scene variable.

4. The method of claim 1, wherein the first processing entity is configured to update the set of scene variables during the interaction process.

5. The method of claim 4, wherein the first processing entity is configured to update a first scene variable in the set of scene variables based on the interactive control information.

6. The method of claim 4, wherein the first processing entity is associated with a workflow, the workflow comprising a variable updating node, the variable updating node being configured to configure an updating strategy associated with a second scene variable in the set of scene variables such that the first processing entity updates the second scene variable based on the updating strategy.

7. The method of claim 1, wherein obtaining the configuration information comprises:
presenting a variable editing interface; and
obtaining variable configuration information via the variable editing interface, the variable configuration information indicating one or more attributes of the set of scene variables, the attributes including at least one of: identifiers of the scene variables; initial values of the scene variables; description information of the scene variables; or visible ranges for the scene variables.

8. The method of claim 1, wherein the target application is configured to:
update second prompt information corresponding to the first processing entity by using the set of scene variables during the runtime of the target application.

9. The method of claim 1, further comprising:
triggering a display of variable information in a target window of the target application, the target window corresponding to a second interactive object, and the variable information indicating a set of values of at least one scene variable provided to the second interactive object.

10. An electronic device, comprising:
at least one processing unit; and
at least one memory, the at least one memory being coupled to the at least one processing unit and storing instructions for execution by the at least one processing unit, the instructions, when executed by the at least one processing unit, cause the electronic device to:
obtain configuration information, the configuration information comprising interactive control information about a target interactive scene, wherein the interactive control information is configured to construct a first processing entity corresponding to the target interactive scene, such that the first processing entity manages, based on the interactive control information, an interaction process for a set of interactive objects participating in the target interactive scene, and the configuration information further indicates a set of scene variables associated with the target interactive scene, each scene variable of the set of scene variables being configured to provide a corresponding value to one or more corresponding interactive objects during the interaction process; and
create a target application based on the configuration information.

11. The electronic device of claim 10, wherein the set of scene variables comprises a target scene variable, and the target application is configured to:
in response to the target scene variable being configured to be provided to a first interactive object corresponding to a second processing entity, update first prompt information corresponding to the second processing entity by using the target scene variable during a runtime of the target application.

12. The electronic device of claim 11, wherein the first prompt information indicates a current value and at least one historical value of the target scene variable.

13. The electronic device of claim 10, wherein the first processing entity is configured to update the set of scene variables during the interaction process.

14. The electronic device of claim 13, wherein the first processing entity is configured to update a first scene variable in the set of scene variables based on the interactive control information.

15. The electronic device of claim 13, wherein the first processing entity is associated with a workflow, the workflow comprising a variable updating node, the variable updating node being configured to configure an updating strategy associated with a second scene variable in the set of scene variables, such that the first processing entity updates the second scene variable based on the updating strategy.

16. The electronic device of claim 10, wherein the electronic device is further caused to:
present a variable editing interface; and
obtain variable configuration information via the variable editing interface, the variable configuration information indicating one or more attributes of the set of scene variables, the attributes including at least one of: identifiers of the scene variables; initial values of the scene variables; description information of the scene variables; or visible ranges for the scene variables.

17. The electronic device of claim 10, wherein the target application is configured to:
update second prompt information corresponding to the first processing entity by using the set of scene variables during the runtime of the target application.

18. The electronic device of claim 10, wherein the electronic device is further caused to:
trigger a display of variable information in a target window of the target application, the target window corresponding to a second interactive object, and the variable information indicating a set of values of at least one scene variable provided to the second interactive object.

19. A non-transitory computer readable storage medium, on which a computer program is stored, wherein the computer program is executable by a processor to implement a method comprising:
obtaining configuration information, the configuration information comprising interactive control information about a target interactive scene, wherein the interactive control information is configured to construct a first processing entity corresponding to the target interactive scene, such that the first processing entity manages, based on the interactive control information, an interaction process for a set of interactive objects participating in the target interactive scene, and the configuration information further indicates a set of scene variables associated with the target interactive scene, each scene variable of the set of scene variables being configured to provide a corresponding value to one or more corresponding interactive objects during the interaction process; and
creating a target application based on the configuration information.

20. The non-transitory computer readable storage medium of claim 19, wherein the set of scene variables comprises a target scene variable, and the target application is configured to:
in response to the target scene variable being configured to be provided to a first interactive object corresponding to a second processing entity, update first prompt information corresponding to the second processing entity by using the target scene variable during a runtime of the target application.
